(19) United States
(12) Patent Application Publication
(10) Pub. No.: US 2005/0008107 A1
(43) Pub. Date: Jan. 13, 2005

(54) Receiver for correcting frequency dependent I/Q phase error

(76) Inventor: James E. C. Brown, San Jose, CA (US)

Correspondence Address: DAVID R. GILDEA;MENLO PATENT AGENCY LLC, 435 HERMOSA WAY, MENLO PARK, CA, 94025, US

(21) Appl. No.: 10/617,281

(22) Filed: Jul. 10, 2003

(51) Int. Cl. H04L 27/06

(52) U.S. Cl. 375/343

(57) ABSTRACT

A signal receiver and a method for correcting frequency dependent IQ phase errors. The receiver uses a calibration tone generator for generating a calibration tone for providing in-phase (I) and quadrature phase (Q) tone components, I and Q filters for filtering the I and Q calibration tone components for issuing filtered I and Q output tones having undesired frequency dependent I/Q phase error, and a correlator for cross correlating the I and Q output tones for providing a correlation feedback signal. At least one of the I and Q filters has at least one adjustable pole and one adjustable zero. The correlation feedback signal adjusts the frequency of the adjustable poles and zeroes for reducing the frequency dependent I/Q phase error.

### BACKGROUND OF THE INVENTION

1. Field of the Invention

The invention relates generally to in-phase (I) and quadrature phase (Q) signal processing in signal receivers and more particularly to methods and apparatus for correcting I/Q phase errors that depend upon frequency of modulation.

2. Description of the Prior Art

In-phase (I) and quadrature phase (Q) signal processing is used in most modem radio signal receivers. The I and Q signals that are derived from an incoming modulated signal should have a phase difference (I/Q phase) of 90° or quadrature at the carrier frequency of the incoming signal and a gain ratio (I/Q gain) of unity. I/Q phase errors and I/Q gain errors degrade the bit rate (BER) performance of the receiver. Imperfections in the frequency downconversion circuitry are known to cause I(Q phase and I/Q gain errors that are independent of modulation frequency. There are several techniques that are known for correcting these frequency independent I/Q phase and I/Q gain errors. However, I/Q phase and I/Q gain errors that are dependent upon modulation frequency are not corrected by these techniques. For a given receiver, the frequency dependent errors typically increase as the modulation frequency increases. A common cause of these frequency dependent I/Q errors is a difference between the frequency responses of I and Q analog baseband filters.

There is a need for a method and apparatus in a radio receiver for correcting frequency dependent I/Q phase error.

### SUMMARY OF THE INVENTION

It is therefore an object of the present invention to provide a method and apparatus in a signal receiver for correcting frequency dependent I/Q phase error.

Briefly, in a preferred embodiment, a signal receiver of the present invention has a normal operation mode and a calibration mode. The receiver includes I and Q filters for providing filtered I and Q signal components in the normal operation mode. These filters introduce an undesired frequency dependent I/Q phase error. In the calibration mode the receiver uses a calibration tone generator for providing in-phase (1) and quadrature phase (Q) tone components to the I and Q filters and a correlator for cross correlating the filtered I and Q output tones for providing a correlation feedback signal. At least one of the I and Q filters is provided with an adjustable characteristic, such as cutoff frequency or phase delay, that can be controlled by adjusting poles and zeroes in the filter. The correlation feedback signal adjusts the adjustable characteristic to minimize the phase difference between the I and Q output tones in order to reduce the frequency dependent I/Q phase error.

An advantage of the present invention is improved performance as a result of the reduction of frequency dependent I/Q phase error.

These and other objects and advantages of the present invention will no doubt become obvious to those of ordinary skill in the art after having read the following detailed description of the preferred embodiments which are illustrated in the various figures.

### IN THE DRAWINGS

FIG. 1 is a block diagram of an embodiment of a signal receiver of the present invention;

FIG. 2 is block diagram of another embodiment of the signal receiver of the present invention;

FIG. 3 is a block diagram of a variation on the signal receiver embodiments of FIGS. 1 and 2;

FIG. 4 is chart showing an adjustable cutoff frequency of an analog filter of the receiver of FIG. 1;

FIG. 5 is chart showing an adjustable phase delay of an allpass filter of the receiver of FIG. 2; and

FIG. 6 is phase plane chart of an adjustable pole-zero pair of the allpass filter of FIG. 5.

### DETAILED DESCRIPTION OF THE PREFERRED EMBODIMENTS

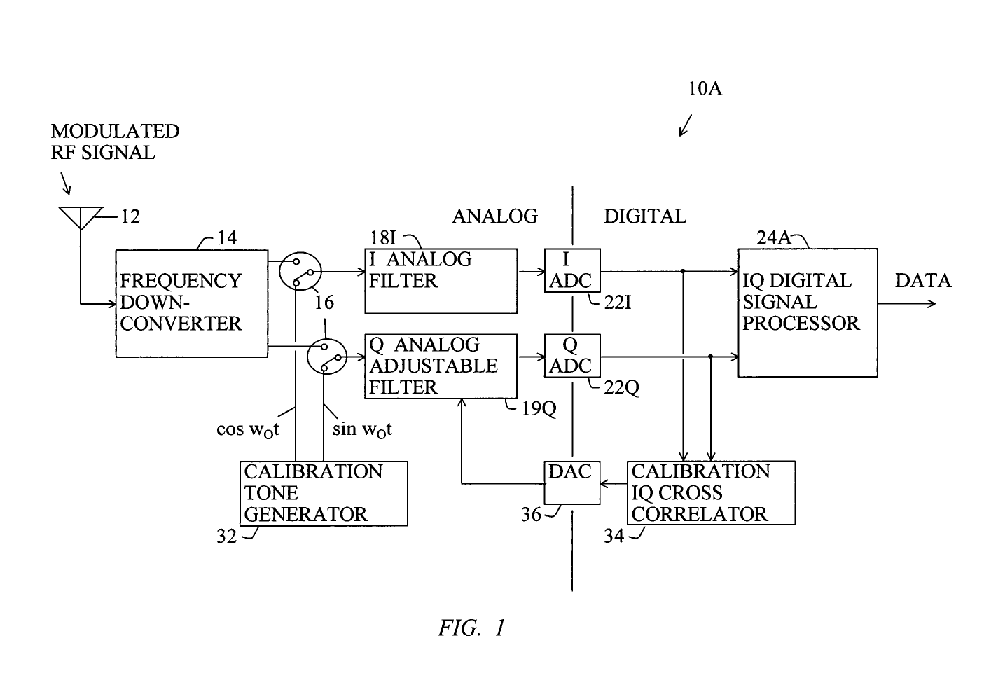

FIG. 1 is a block diagram of a signal receiver 10A of the present invention. The receiver 10A includes an antenna 12, a frequency downconverter 14, a calibration mode switch 16, I and Q analog filters 18I and 19Q, I and Q analog-to-digital converters (ADC)s 22I and 22Q, and an IQ digital signal processor 24A. In normal operation, the antenna 12 converts an incoming modulated radio frequency (RF) signal from an airwave signal to a conducted signal and passes the conducted signal to the frequency downconverter 14. The frequency downconverter 14 downconverts the RF conducted signal to I and Q signal components at baseband and passes the I and Q signal components through the calibration mode switch 16 (herein illustrated in a in switch state for a calibration mode) to the I and Q analog filters 18I and 19Q.

The I and Q analog filters 18I and 19Q filter the I and Q signal components and pass the filtered analog I and Q signal components to the ADCs 22I and 22Q. The ADCs 22I and 22Q convert the filtered analog I and Q signal components to digital form and pass the digital I and Q signal components to the IQ digital signal processor 24A. The IQ digital signal processor 24A processes the digital I and Q signal components for providing data that is representative of the modulation on the incoming RF signal. For the lowest or best bit error rate (BER), the I and Q signal components should be in quadrature. The degree to which the I and Q signal components deviate from quadrature is termed I/Q phase error. An I/Q phase error that increases as the modulation frequency increases is termed frequency dependent I/Q phase error.

The frequency dependent I/Q phase error in the digital I and Q signals is caused primarily by mismatch between the phase responses of the I and Q analog filters 18I and 19Q. In order to reduce this error, the receiver 10A uses a calibration tone generator 32, a calibration IQ cross correlator 34, and a digital to analog converter 36. In the calibration mode, the calibration tone generator 32 generates a calibration signal or tone having quadrature tone components coswₒt (I) and sinwₒt (Q). The calibration mode switch 16 is switched to the calibration mode state and the I and Q calibration tone components replace the normal I and Q signal components to the I and Q analog filters 18I and 19Q. The filtered I and Q calibration tone components are then digitized by the I and Q ADCs 22I and 22Q and passed as I and Q output signals or tones to the calibration IQ cross correlator 34.

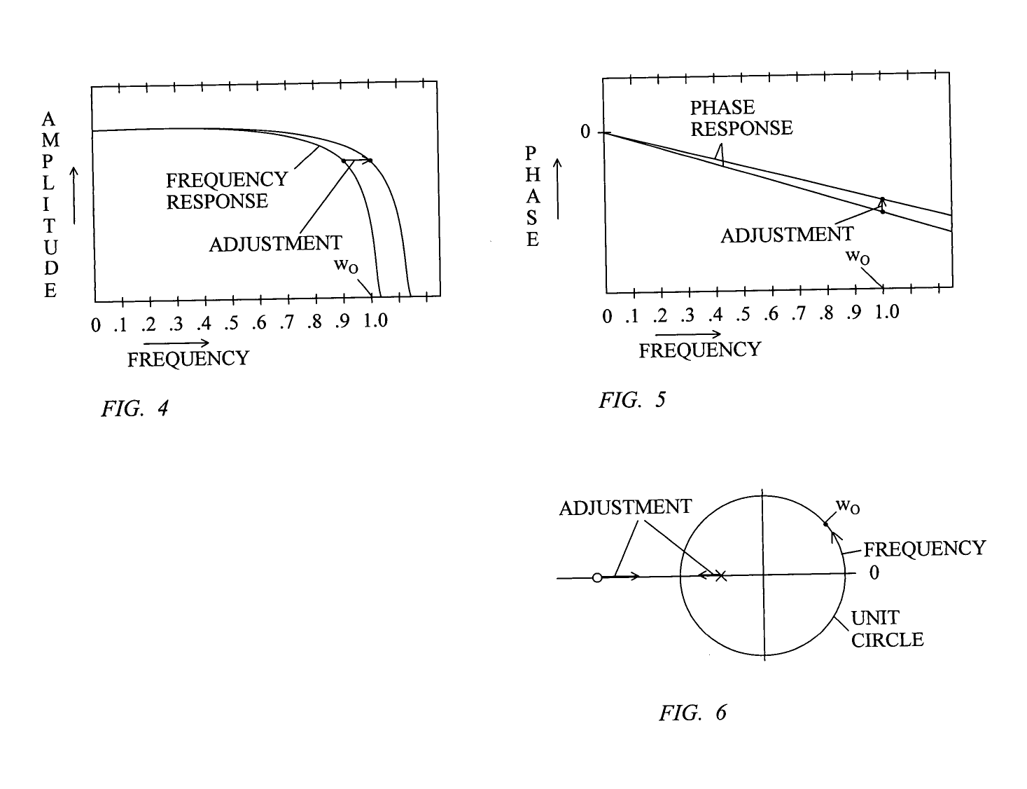

The calibration IQ cross correlator 34 correlates the I and Q output tones from the I and Q ADCs 22I and 22Q for providing a cross correlation feedback signal. The cross correlation feedback signal is converted from a digital to an analog form and then used to control the frequency cutoff of the Q analog filter 19Q. The I and Q analog filters 18I and 19Q have an approximate cutoff frequency in radians/second of wₒ. The action of the feedback adjusts the cutoff frequency of the Q analog filter 19Q (or alternatively the I analog filter 18I) to drive the cross correlation feedback signal near to zero by minimizing the phase difference between the I and Q output tones at the radian frequency wₒ (see FIG. 4). By minimizing the phase difference between the I and Q output tones at the radian frequency wₒ, the frequency dependent I/Q phase error of the receiver 10A is reduced. It should be obvious that the Q analog filter 19Q and the I analog filter 18I are interchangeable for the adjustable purpose of the present invention and that either or both of the I and Q analog filters 18I and 19Q can be adjusted for the present invention.

It should be noted that the frequency dependent I/Q phase error is reduced by adjusting the phase of the Q output tone to match the phase of the I output tone at the radian frequency wₒ and that this is accomplished by adjusting the cutoff frequency of the Q analog filter 19Q. Of course, there are other filter types and devices having other adjustable charateristics within the idea of the present invention.

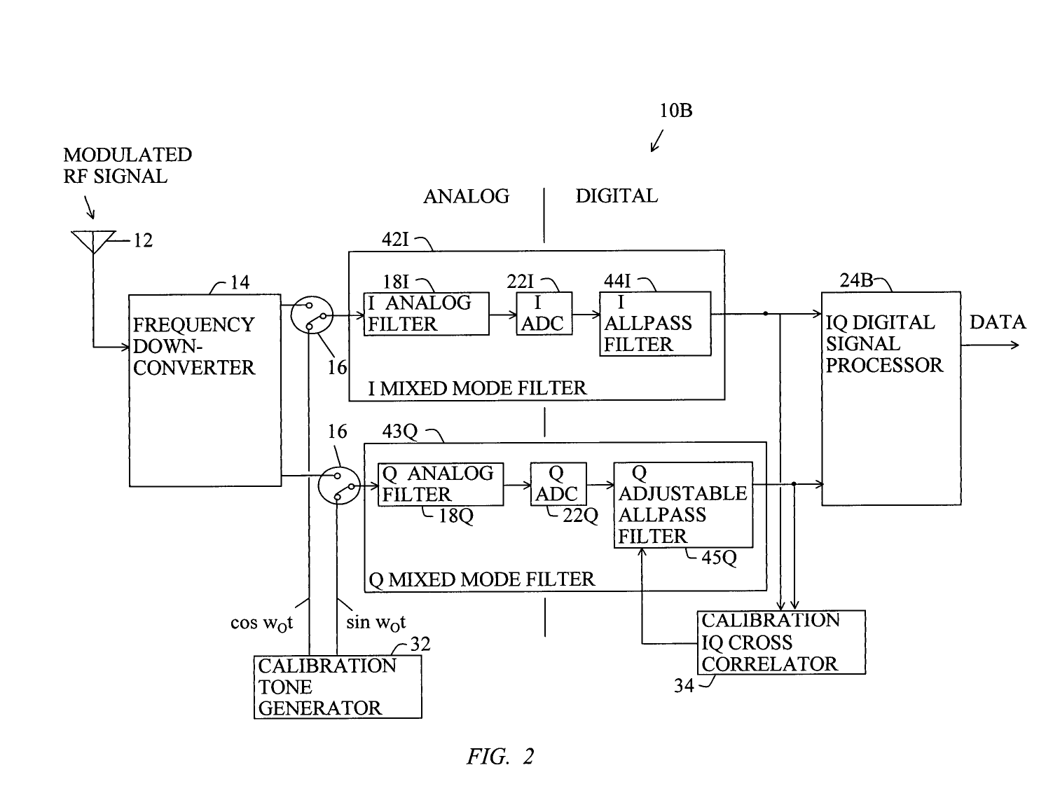

FIG. 2 is a block diagram of a signal receiver 10B of the present invention. The receiver 10B includes the antenna 12, the frequency downconverter 14 and the calibration mode switch 16, and uses the calibration tone generator 32 and the calibration IQ cross correlator 34 as described above.

The receiver 10B differs from the receiver 10A by having I and Q mixed mode filters 42I and 43Q. The I mixed mode filter 42I includes the I analog filter 18I, the I ADC 22I and a digital I allpass filter 44I. Similarly, the Q mixed mode filter 43Q includes a Q analog filter 18Q, the Q ADC 22Q and a digital Q allpass filter 45Q. In the normal mode digital I and Q signal components from the I and Q ADCs 22I and 22Q are passed to the I and Q allpass filters 44I and 45Q. The I and Q allpass filters 44I and 45Q delay the digital 10 I and Q signal components and pass the delayed I and Q signal components to the IQ digital signal processor 24B. The IQ digital signal processor 24B processes the delayed I and Q signal components for providing data that is representative of the modulation on the incoming RF signal.

For the calibration mode, the calibration tone generator 32 generates a calibration tone having quadrature tone components coswₒt (D and sinwₒt (Q). The calibration mode switch 16 is switched to the calibration mode and the I and Q calibration tone components replace the normal I and Q signal components to the I and Q analog filters 18I and 18Q. The I and Q calibration tone components are filtered by the I and Q analog filters 18I and 18Q, digitized by the I and Q ADCs 22I and 22Q, and then delayed by the I and Q allpass filters 44I and 45Q for providing filtered I and Q output tones to the calibration IQ cross correlator 34.

The calibration IQ cross correlator 34 correlates the I and Q output tones from the I and Q allpass filters 44I and 45Q for providing the cross correlation feedback signal. The cross correlation feedback signal is used to control the delay (phase) in the Q allpass filter 45Q at the radian frequency wₒ (see FIG. 5). The action of the feedback adjusts the phase delay of the Q allpass filter 45Q (or alternatively the I allpass filter 44I) to minimize the cross correlation feedback signal by minimizing the phase difference between the I and Q allpass calibration tone components at the radian frequency wₒ (see FIG. 5). Minimizing the phase difference between the I and Q output tones at the radian frequency wₒ reduces the frequency dependent I/Q phase error of the receiver 10B. It should be obvious that the Q allpass filter 45Q and the I allpass filter 44I are interchangeable for the adjustable purpose of the present invention and that either or both of the I and Q allpass filters 44I and 45Q can be adjusted for the present invention.

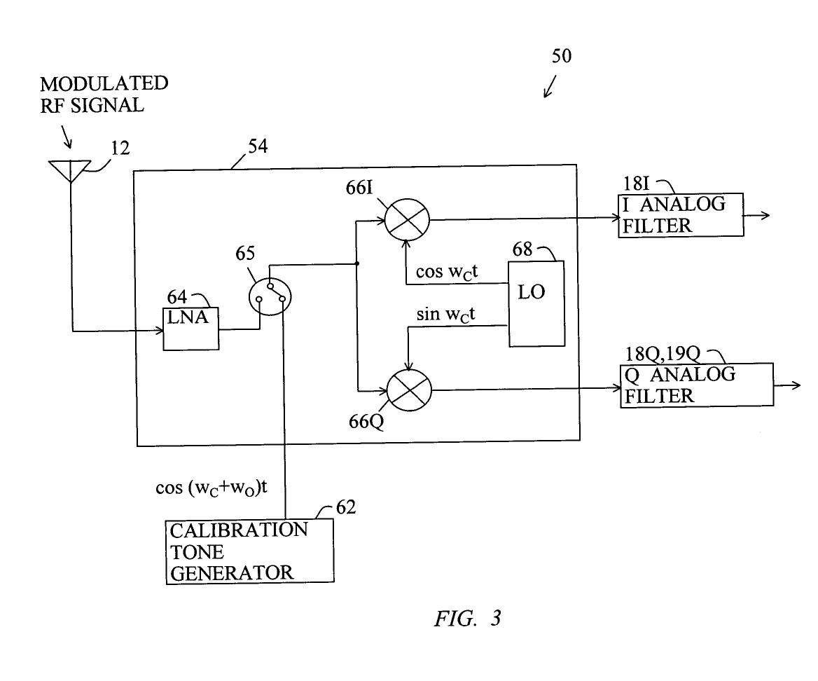

FIG. 3 is a block diagram of a radio frequency (RF) variation, denoted by a general reference 50, of the receivers 10A and 10B for the present invention. The receiver 50 includes the antenna 12, a frequency downconverter 54, and a calibration tone generator 62. In normal operation, the antenna 12 converts the incoming modulated radio frequency (RF) signal from an airwave signal to a conducted signal and passes the conducted signal to the frequency downconverter 54. The frequency downconverter 54 includes a low noise amplifier (LNA) 64, a calibration mode switch 65, I and Q frequency downconverters 66I and 66Q, and a local oscillator system (LO) 68 for frequency converting the RF conducted signal to the I and Q signal components as described above. The calibration tone generator 62 replaces the calibration tone generator 32 and the calibration mode switch 65 replaces the calibration mode switch 16.

The LNA 64 amplifies the RF conducted signal from the antenna 12 and passes the amplified signal through the calibration mode switch 65 (shown for the calibration mode) to the I and Q frequency downconverters 66I and 66Q. The I and Q downconverters 66I and 66Q use quadrature LO signals cosw_{c}t and sinw_{c}t from the LO 68 for downconverting the amplified RF signal to the I and Q signal components and passes the I and Q signal components to the I and Q analog filters 18I and 19Q for the receiver 10A or 42I and 43Q for the receiver 10B. The I and Q frequency downconverters 66I and 66Q include well known devices such as amplifiers, mixers, samplers, phase shifters and filters for one or more frequency up and down conversion stages with a net effect that the input frequency is downconverted to the output frequency. Each of the frequency conversion stages may use several frequency conversion devices in parallel.

In the calibration mode the calibration tone generator 62 generates a calibration frequency offset tone cos(w_{c}+wₒ)t. The calibration tone cos(w_{c}+wₒ)t mixes with the quadrature LO signals cosw_{c}t and sinw_{c}t in the I and Q frequency downconverters 66I and 66Q for providing the quadrature I and Q tone components coswₒt and sinwₒt as described above to the I and Q filters 18I and 19Q for the receiver 10A or the I and Q filters 42I and 43Q for receiver 10B.

The calibration elements of the calibration mode switch 16 or 65, the calibration tone generator 32 or 62, and/or the calibration IQ cross correlator 34 may be built in to the receiver embodiments 10A and 10B and variation 50 or may be used for calibration and then removed.

FIG. 4 is a chart illustrating amplitude versus frequency (denoted as frequency response) for the I analog filter 18I and the Q analog adjustable filter 19Q in the receiver 10A. The frequency responses of the I and Q analog filters 18I and 19Q may have a cutoff frequency within less than about ten percent of wₒ. In a variation of the present invention, the radian frequency wₒ of the I and Q calibration tone may be in a range of fifty percent to one hundred percent of the maximum modulation or data frequency. The frequency response of the Q analog adjustable filter 19Q is adjusted by an adjustment that is controlled by the cross correlation feedback signal (so that the cross correlation feedback signal is about zero) for reducing the frequency dependent I/Q phase error. Such adjustment may be made by equally scaling all poles and zeros in the Q analog adjustable filter 19Q. The poles and zeroes may be constructed using resistances and capacitances. In an integrated circuit having metal oxide silicon (MOS) field effect transistors (FET)s and capacitors, this may be accomplished by controlling the gate biases of the MOSFETs in order to control the channel resistances of the MOSFETs.

FIG. 5 is a chart illustrating delay (phase) versus frequency (denoted phase response) for the I allpass filter 44I and the Q adjustable allpass filter 45Q in the receiver 10B. The phase at the radia frequency wₒ lags the phase at zero frequency. The amount of the lag in the Q adjustable allpass filter 45Q is adjusted by an adjustment that is controlled by the cross correlation feedback signal so that the cross correlation feedback signal is driven to near zero, thereby reducing the frequency dependent I/Q phase error.

FIG. 6 is a chart illustrating a complex phase plane for the I and Q allpass filters 44I and 45Q for the receiver 10B. A pole-zero pair is illustrated with a pole “x” and a zero “o”. Radian frequency is represented by the angle around a unit circle from zero (0) frequency to the radian frequency wₒ and beyond. The phase response of the I allpass filters 44I (or the Q allpass filter 45Q) is determined from the location of the pole x and the zero o with respect to the radian frequency on the unit circle. The pole x and zero o pair are geometrically centered about the unit circle on the negative real axis with the pole x inside the unit circle (for example when the pole x is 2/3 units, the zero o is 3/2 units). The adjustment is made by inversely scaling one or more pole-zero pairs in the Q adjustable allpass filter 45Q (multiplying the frequency of the pole x and dividing the frequency of the zero o by the same factor). In an integrated circuit using metal oxide silicon (MOS) field effect transistors (FET)s and capacitors, this may be accomplished by controlling the gate biases of the MOSFETs in order to control the channel resistances.

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

1. A signal receiver having calibration for a frequency dependent I/Q phase error, comprising:
a calibration tone generator for generating a calibration tone for providing in-phase (I) and quadrature phase (Q) tone components;
I and q filters for filtering said I and Q calibration tones for issuing filtered I and Q output tones having an undesired frequency dependent I/Q phase error, at least one of the I and Q filters having an adjustable characteristic; and
a correlator for cross correlating said I and Q output tones for providing a cross correlation feedback signal, said correlation feedback signal used for adjusting said adjustable characteristic for reducing said frequency dependent I/Q phase error:

2. The receiver of claim 1, wherein:
said correlation feedback signal adjusts said adjustable characteristic for minimizing a phase difference between said I output tone and said Q output tone.

3. The receiver of claim 1, wherein:
said calibration tone has a frequency near to a cutoff frequency for said I and Q filters.

4. The receiver of claim 1, wherein:
the I and Q filters include an I analog filter for providing said I output tone and a Q analog filter for providing said Q output tone; and
said adjustable characteristic is a cutoff frequency of at least one of said I and Q analog filters.

5. The receiver of claim 4, wherein:
said cutoff frequency is adjusted by frequency scaling at least one pole and at least one zero of said at least one of said I and Q analog filters by a certain common factor.

6. The receiver of claim 4, wherein:
said certain common scale factor is adjusted by adjusting channel resistance of at least one transistor.

7. The receiver of claim 1, wherein:
the I and Q filters include I and Q allpass filters for providing said I and Q output tones; and
said adjustable characteristic is a phase delay of at least one of said I and Q allpass filters.

8. The receiver of claim 7, wherein:
said phase delay is adjusted by frequency scaling at least one pole by a certain factor and frequency scaling at least one zero by an inverse of said certain factor in said at least one of said I and Q allpass filters.

9. The receiver of claim 1, further comprising:
a frequency downconverter including a local oscillator for providing a complex LO signal and I and Q frequency downconverters using said LO signal for downconverting an input signal having a carrier frequency to I and Q signal components; and wherein:
the calibration tone generator issues a calibration signal as said input signal having a certain frequency offset from said carrier frequency for providing said I and Q calibration tone components in place of said I and Q signal components.

10. A method for correcting frequency dependent I/Q phase error, comprising: generating a calibration tone for providing in-phase (I) and quadrature phase (Q) tone components;
filtering said I and Q calibration tones for providing filtered I and Q output tones having undesired frequency dependent I/Q phase error;
cross correlating said I and Q output tones for providing a cross correlation feedback signal; and
adjusting an adjustable characteristic of at least one of the I and Q filters with said correlation feedback signal for reducing said frequency dependent I/Q phase error.

11. The method of claim 10, wherein:
the step of adjusting said adjustable characteristic includes minimizing a phase difference between said I output tone and said Q output tone.

12. The method of claim 10, wherein:
said calibration tone has a frequency near to a cutoff frequency for said I and Q filters.

13. The method of claim 10, wherein:
the step of filtering said I and Q calibration tones includes filtering said I calibration tone component with an I analog filter for providing said I output tone; and filtering said Q calibration tone component with a Q analog filter for providing said Q output tone; and the step of adjusting said adjustable characteristic includes adjusting a cutoff frequency of at least one of said I and Q analog filters.

14. The method of claim 13, wherein:
the step of adjusting said cutoff frequency includes frequency scaling at least one pole and at least one zero of said at least one of said I and Q analog filters by a certain common factor.

15. The method of claim 13, wherein:
said step of frequency scaling includes adjusting channel resistance of at least one transistor.

16. The method of claim 10, wherein:
the step of filtering said I and Q calibration tone components includes passing the I and Q calibration tones through I and Q allpass filters for providing said I and Q output tones; and the step of adjusting said adjustable characteristic includes adjusting a phase delay of at least one of said I and Q allpass filters.

17. The method of claim 16, wherein:
the step of adjusting said phase response includes frequency scaling at least one pole by a certain factor and frequency scaling at least one zero by an inverse of said certain factor in said at least one of said I and Q allpass filters.

18. The method of claim 10, further comprising:
frequency downconverting an input signal having a carrier frequency with a complex LO signal to I and Q signal components; and wherein:
the step of generating said calibration tone includes issuing a calibration signal as said input signal having a certain frequency offset from said carrier frequency for providing said I and Q calibration tone components in place of said I and Q signal components.
